(19) United States
(12) Patent Application Publication
(10) Pub. No.: US 2022/0222645 A1
(43) Pub. Date: Jul. 14, 2022

(54) SALES SUPPORT DEVICE AND SALES SUPPORT METHOD THEREOF

(71) Applicant: TOSHIBA TEC KABUSHIKI KAISHA, Tokyo (JP)

(72) Inventor: Daisuke MIYAGI, Fuji Shizuoka (JP)

(73) Assignee: TOSHIBA TEC KABUSHIKI KAISHA, Tokyo (JP)

(21) Appl. No.: 17/519,861

(22) Filed: Nov. 5, 2021

(30) Foreign Application Priority Data
Jan. 14, 2021 (JP) 2021-004307

(51) Int. Cl. G06Q 20/20; G01G 19/414; G06Q 20/40

(52) U.S. Cl. CPC G06Q 20/208; G01G 19/4144; G06Q 20/40; G06Q 20/206; G06Q 20/203

(57) ABSTRACT

A sales support device includes a weight measurement device for measuring a weight of a product displayed in a display section and a processor. The processor is configured to acquire, from the weight measurement device, a decrease amount if the weight of the product measured by the weight measurement device is decreased, specify, based on images captured by a camera, a customer who takes out the product for which the weight is decreased from the display section, and output identification information of the customer specified and information related to a sale of the product based on the decrease amount acquired to a sales management device that manages the information related to the sale in association with the identification information of the customer.

### CROSS-REFERENCE TO RELATED APPLICATION

This application is based upon and claims the benefit of priority from Japanese Patent Application No. 2021-004307, filed on Jan. 14, 2021, the entire contents of which are incorporated herein by reference.

### FIELD

Embodiments described herein relate generally to a sales support device and a sales support method thereof.

### BACKGROUND

In recent years, various store systems have been proposed that automatically register products purchased by a consumer based on the behavior of the consumer in the store, thereby eliminating the need for product registration at the time of payment. One example is a store system that specifies that a purchaser of a product is a consumer near a shelf who motions to take out the product, if the product is taken out from the shelf. It is possible to achieve an unmanned store by introducing this type of store system in convenience stores, small shops, and the like, for example.

With this type of store system, it is possible to specify who purchases which product. However, it is not possible to specify an amount of the product purchased. For this reason, it is not applied to the sale of product-sold-by-weight, for which the unit price per unit weight was set. For example, it is desired to develop a technology for supporting the sale of product-sold-by-weight for unmanned stores.

### DESCRIPTION OF THE DRAWINGS

FIG. 1 is a perspective view schematically illustrating an appearance of a display fixture according to an embodiment;

FIG. 2 is a block diagram illustrating a circuit configuration of a main part of the display fixture and a schematic configuration of a store system;

FIG. 3 is a block diagram illustrating a circuit configuration of a main part of a user interface unit;

FIG. 4 is a block diagram illustrating a circuit configuration of a main part of a product monitoring unit;

FIG. 5 is a diagram schematically illustrating a configuration of a data record included in a product management database;

FIG. 6 is a block diagram illustrating a circuit configuration of a main part of a main processing unit;

FIG. 7 is a diagram schematically illustrating a configuration of a data record included in a tracking database;

FIG. 8 is a diagram schematically illustrating a configuration of a data record included in a membership management database;

FIG. 9 is a plan view illustrating a state of areas set in a tracking area;

FIG. 10 is a flowchart of a tracking process;

FIG. 11 is a flowchart of the tracking process;

FIG. 12 is a flowchart of a monitoring process;

FIG. 13 is a flowchart of a customer response process; and

FIG. 14 is a flowchart of the customer response process.

### DETAILED DESCRIPTION

An exemplary embodiment of a sales support device capable of supporting the sale of a product-sold-by-weight and a sales support method thereof is provided herein.

In general, according to at least one embodiment, a sales support device includes a measuring means, a decrease amount acquisition means, a specifying means, and an output means. The measuring means measures a weight of a product displayed in a display section. The decrease amount acquisition means acquires a decrease amount if the weight of the product measured by the measuring means is changed in a decrease direction. The specifying means specifies a customer who takes out the product for which the weight is changed in the decrease direction from the display section. The output means outputs identification information of the customer specified by the specifying means and the information related to a sale of the product based on the decrease amount acquired by the decrease amount acquisition means. The output means outputs the identification information and the information related to the sale to the sales management device that manages the information related to the sale in association with the identification information of the customer.

Hereinafter, embodiments will be described with reference to the drawings. In at least one embodiment, a store system using a shelf-type display fixture will be described as an example. Further, an example will be described, in which the store system processes a transaction in which a customer purchases a product-sold-by-weight displayed in a store.

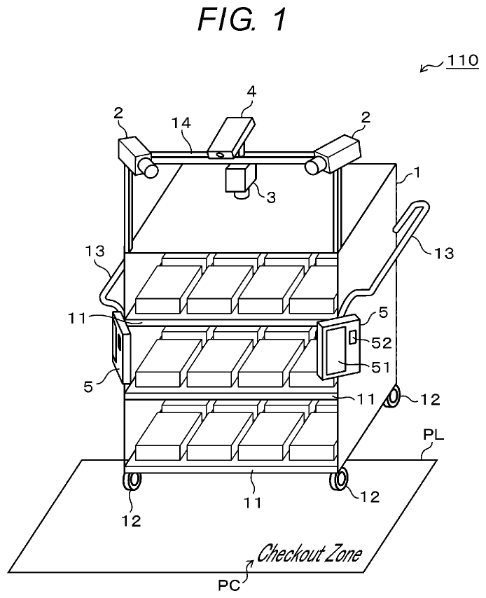

FIG. 1 is a perspective view schematically illustrating an appearance of a display fixture 110 according to at least one embodiment.

The display fixture 110 is an example of a sales support device that supports the sale of a product-sold-by-weight. The display fixture 110 is mainly formed of a shelf 1. The shelf 1 is a shelf specialized for a product-sold-by-weight. The shelf 1 is formed as a hollow rectangular parallelepiped with one side open. The shelf 1 includes a plurality of shelf boards 11, a plurality of casters 12, a plurality of handles 13, and a support member 14.

The shelf boards 11 are installed in an internal space. While any number and position of the shelf boards 11 are possible, FIG. 1 illustrates an example where there are three. As illustrated in the drawing, containers containing the products-sold-by-weight therein are displayed on the shelf boards 11. Thus, the shelf 1 serves as a display section for displaying the products-sold-by-weight.

The casters 12 are attached to a bottom of the shelf 1. The casters 12 allow the display fixture 110 to be easily moved on the floor.

The handles 13 are attached to outer surfaces of each of two sidewalls orthogonal to an open surface of the shelf 1. An operator holds the handles 13 when moving the display fixture 110. Any number and position of the handles 13 are possible. It should be noted that the handles 13 may be omitted.

The support member 14 is attached to an outer surface of a top plate of the shelf 1, while protruding upward. The support member 14 supports two tracking cameras 2, a surveillance camera 3, and a projector 4.

The two tracking cameras 2 capture an image of a person present in a capturing area that includes a purchase area, a detection area, a preparatory area, and a confirm area, which will be described below. The two tracking cameras 2 may each capture images inside the capturing area, or images of a portion of the capturing area may be captured by only one tracking camera 2. Only one of the tracking camera 2 may be provided, or another one or a plurality of tracking cameras 2 may be additionally provided. Any position of the tracking camera 2 is also possible. The images captured by the tracking camera 2 are used for tracking a person. This tracking will be described below. For the tracking camera 2, a well-known camera device such as an optical camera, an infrared camera, a time of flight (TOF) camera, and a stereo camera can be used. For the tracking camera 2, a camera device suitable for measuring a distance to a subject, such as a TOF camera and a stereo camera is suitable.

The surveillance camera 3 captures images of the open surface of the shelf 1 and the space outside the shelf 1 from the open surface. The images captured by the surveillance camera 3 are used to monitor the behavior of a person reaching out to the shelf 1. This monitoring will be described below. For the surveillance camera 3, a well-known camera device such as an optical camera, an infrared camera, a TOF camera, and a stereo camera can be used. For the surveillance camera 3, a camera device suitable for measuring a distance to a subject, such as a TOF camera and a stereo camera, is suitable.

The projector 4 projects any image on the floor surface. Lines PL and letters PC illustrated in FIG. 1 are included in the image projected by the projector 4. The projector 4 may be omitted, provided that measures such as laying a mat having a size corresponding to the range represented by the lines PL are taken.

User interface units (hereinafter referred to as UI units) 5 (e.g., a user interface, a user interface device) are attached to both ends of the open surface of the shelf 1. The UI unit 5 includes a touch panel 51 and a reader 52, and performs a user interface operation. The touch panel 51 and the reader 52 will be described below. If it is necessary to distinguish between the two UI units 5 in the following description, the UI unit 5 illustrated on the left side in FIG. 1 is referred to as a “first UI unit 5”, and the other UI unit 5 is referred to as a “second UI unit 5”.

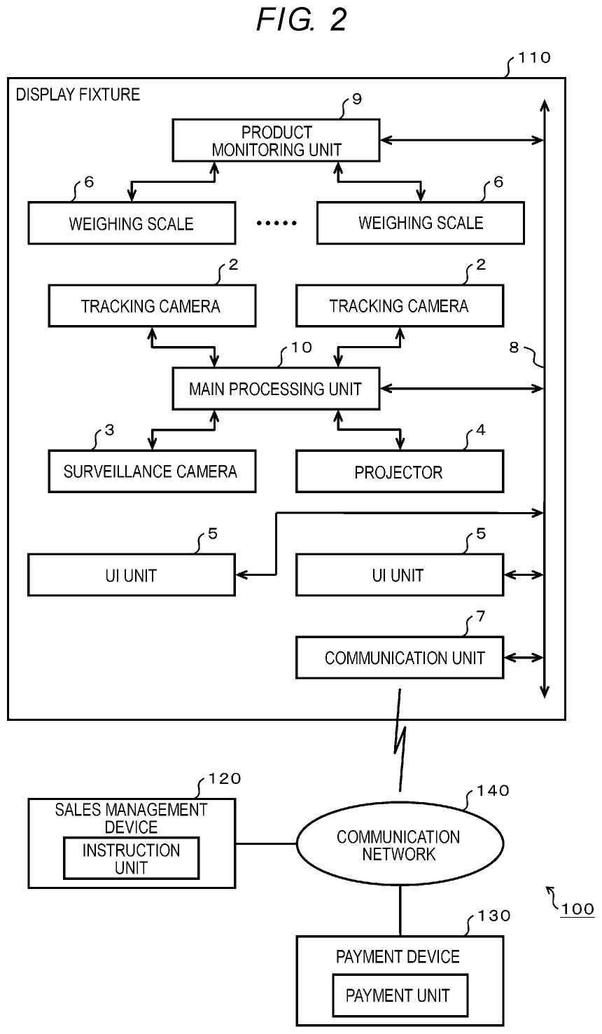

FIG. 2 is a block diagram illustrating a circuit configuration of a main part of the display fixture 110 and a schematic configuration of the store system 100. In FIG. 2, elements identical to those illustrated in FIG. 1 are designated by the same reference numerals.

The store system 100 is configured by the display fixture 110, a sales management device 120, and a payment device 130 which are capable of communicating with each other via a communication network 140.

The sales management device 120 is a device that manages the sale of the product-sold-by-weight displayed on the display fixture 110. The sales management device 120 has a function of an instruction unit (e.g., an instruction device, an instructor). The instruction unit is a function for instructing the payment device 130 to pay the price of the product-sold-by-weight. The payment device 130 is a payment device that processes a payment for the sale of the product-sold-by-weight displayed on the display fixture 110. The payment device 130 has a function of a payment unit (e.g., a payment device). The payment unit is a function for paying the price of the product-sold-by-weight.

For the communication network 140, for example, the Internet, virtual private network (VPN), local area network (LAN), public communication network, mobile communication network and the like may be used alone or in combination as appropriate. The display fixture 110, the sales management device 120, and the payment device 130 are provided in one store, for example. In this case, in-store LAN is typically used as the communication network 140.

In addition to the tracking cameras 2, the surveillance camera 3, the projector 4, and the UI units 5 illustrated in FIG. 1, the display fixture 110 includes a plurality of weighing scales 6 (e.g., a plurality of weight measurement devices), a communication unit 7 (e.g., a communication device), a communication path 8 in the fixture, a product monitoring unit 9 (e.g., a product monitoring device), and a main processing unit 10 (e.g., a main processor).

The tracking cameras 2, the surveillance camera 3, and the projector 4 are connected to the main processing unit 10. Further, the UI units 5 are connected to the communication path 8 in the fixture.

The plurality of weighing scales 6 are provided on the shelf boards 11 and measure the weights of the products-sold-by-weight that are contained in the container and displayed on the shelf board 11. The weighing scales 6 output measurement data indicating the measured weights to the product monitoring unit 9. The weighing scales 6 are prepared for each product-sold-by-weight. The weighing scales 6 are an example of a measuring portion.

The communication unit 7 performs wireless communication for data exchange via the communication network 140. For the communication unit 7, if the communication network 140 is a LAN, for example, a well-known communication device compliant with the IEEE802.11 standard can be used. However, for the communication unit 7, a communication device that performs wired communication may be used.

The communication path 8 in the fixture enables the UI units 5, the communication unit 7, the product monitoring unit 9, and the main processing unit 10 to exchange data with each other. For example, a LAN is used for the communication path 8 in the fixture.

The product monitoring unit 9 is an information processing unit (e.g., an information processor) that performs information processing for monitoring the display status of product-sold-by-weight on the shelf 1 based on the measurement data given from the weighing scale 6.

The main processing unit 10 is an information processing unit (e.g., an information processor) that specifies a person who takes out a product-sold-by-weight from the shelf 1, based on the images captured by the tracking camera 2 and the surveillance camera 3, and performs information processing for causing the person to pay the price of the product-sold-by-weight.

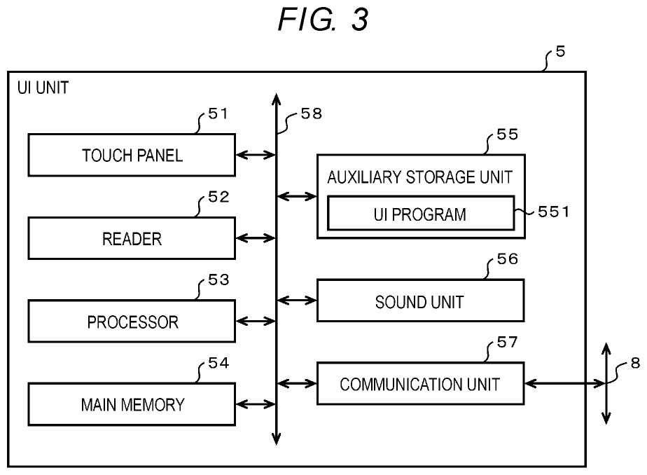

FIG. 3 is a block diagram illustrating a circuit configuration of a main part of the UI unit 5. In FIG. 3, elements identical to those illustrated in FIGS. 1 and 2 are designated by the same reference numerals.

The UI unit 5 includes a processor 53, a main memory 54, an auxiliary storage unit 55 (e.g., an auxiliary storage device, an auxiliary memory), a sound unit 56 (e.g., a sound device), a communication unit 57 (e.g., a communication device), and a transmission line 58, in addition to the touch panel 51 and the reader 52 illustrated in FIG. 1.

The processor 53, the touch panel 51, the reader 52, the main memory 54, the auxiliary storage unit 55, the sound unit 56, and the communication unit 57 are capable of communicating with each other via the transmission line 58.

The touch panel 51 is a display device that displays various screens such as an operation screen. The touch panel 51 is an operation device that receives operations in response to the operation screen.

The reader 52 reads a member ID (identifier) from a medium carried by the customer. For the reader 52, a well-known data reading device that reads a visible code such as a barcode or a two-dimensional code displayed on card surface or display device can be used. For the reader 52, it is also possible to use another type of well-known data reading device such as a well-known magnetic card reader, an integrated circuit (IC) card reader, a non-contact card reader, or the like. The reader 52 may include a plurality of types of reading devices.

A computer for controlling the UI unit 5 is configured by connecting the processor 53, the main memory 54, and the auxiliary storage unit 55 with the transmission line 58.

The processor 53 corresponds to the central part of the computer. The processor 53 executes information processing for realizing various functions of the UI unit 5 according to an operating system and an information processing program such as an application program. The processor 53 is a central processing unit (CPU) (e.g., a central processor), for example.

The main memory 54 corresponds to a main memory portion of the computer. The main memory 54 includes a non-volatile memory area and a volatile memory area. The main memory 54 stores the information processing program described above in the non-volatile memory area. The main memory 54 may store data necessary for the processor 53 to execute information processing in a non-volatile or volatile memory area. The main memory 54 uses the volatile memory area as a work area in which data is appropriately rewritten by the processor 53. The non-volatile memory area is a read only memory (ROM), for example. The volatile memory area is a random access memory (RAM), for example.

The auxiliary storage unit 55 corresponds to an auxiliary storage portion of the computer. The auxiliary storage unit 55 may include a storage unit (e.g., a memory) using a well-known storage device such as electric erasable programmable read-only memory (EEPROM) (registered trademark), hard disk drive (HDD), solid state drive (SSD), and the like. The auxiliary storage unit 55 stores data used by the processor 53 to perform various processes, data generated by the processes of the processor 53, and the like. The auxiliary storage unit 55 may store the information processing program described above.

The sound unit 56 outputs various sounds such as voice and melody.

The communication unit 57 is an interface for data communication via the communication path 8 in the fixture. For the communication unit 57, for example, a well-known communication device for performing data communication via a LAN can be used.

The transmission line 58 includes an address bus, a data bus, a control signal line, and the like, and transmits data and control signals exchanged between the connected units.

The auxiliary storage unit 55 stores a UI program 551 which is one of the information processing programs. The UI program 551 is an application program, and describes information processing for causing the UI unit 5 to function as a user interface of the display fixture 110.

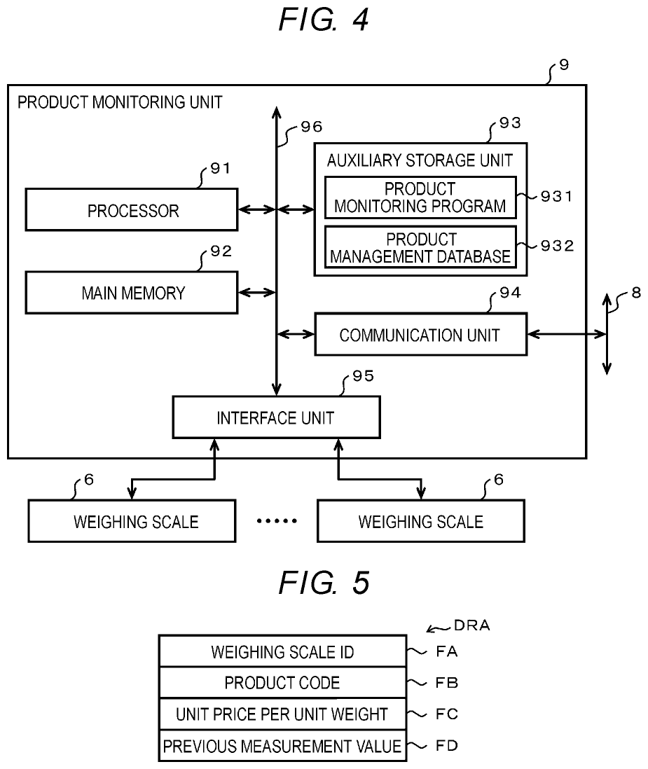

FIG. 4 is a block diagram illustrating a circuit configuration of a main part of the product monitoring unit 9. In FIG. 4, elements identical to those illustrated in FIGS. 1 and 2 are designated by the same reference numerals.

The product monitoring unit 9 includes a processor 91, a main memory 92, an auxiliary storage unit 93 (e.g., an auxiliary storage device, an auxiliary memory), a communication unit 94 (e.g., a communication device), an interface unit 95 (e.g., an interface device, a user interface), and a transmission line 96.

The processor 91, the main memory 92, the auxiliary storage unit 93, the communication unit 94, and the interface unit 95 can communicate with each other via the transmission line 96. A computer for controlling the product monitoring unit 9 is configured by connecting the processor 91, the main memory 92, and the auxiliary storage unit 93 with the transmission line 96.

The processor 91 corresponds to the central part of the computer. The processor 91 executes information processing for realizing various functions of the product monitoring unit 9 according to an operating system and an information processing program such as an application program. The processor 91 is a CPU, for example.

The main memory 92 corresponds to a main memory portion of the computer. The main memory 92 includes a non-volatile memory area and a volatile memory area. The main memory 92 stores the information processing program described above in the non-volatile memory area. The main memory 92 may store data necessary for the processor 91 to execute information processing in a non-volatile or volatile memory area. The main memory 92 uses the volatile memory area as a work area in which data is appropriately rewritten by the processor 91. The non-volatile memory area is a ROM, for example. The volatile memory area is a RAM, for example.

The auxiliary storage unit 93 corresponds to an auxiliary storage portion of the computer. For the auxiliary storage unit 93, a storage unit (e.g., a memory) using a well-known storage device such as EEPROM, HDD, SSD, and the like can be used. The auxiliary storage unit 93 stores data used by the processor 91 to perform various processes, data generated by the processes of the processor 91, and the like. The auxiliary storage unit 93 may store the information processing program described above.

The communication unit 94 is an interface for data communication via the communication path 8 in the fixture. For the communication unit 94, for example, a well-known communication device for performing data communication via a LAN can be used.

A plurality of weighing scales 6 are connected to the interface unit 95, respectively. The interface unit 95 interfaces the exchange of data between the processor 91 and the weighing scale 6. As the interface unit 95, a well-known device such as various interface boards such as a universal serial bus (USB) board can be used. A plurality of interface units 95 may be provided.

The transmission line 96 includes an address bus, a data bus, a control signal line, and the like, and transmits data and control signals exchanged between the connected units.

The auxiliary storage unit 93 stores a product monitoring program 931 which is one of the information processing programs. The product monitoring program 931 is an application program, and describes information processing described below for realizing the function of the product monitoring unit 9. A portion of the storage area of the auxiliary storage unit 93 is used as a storage area of a product management database 932. The product management database 932 is a database for managing the product-sold-by-weight displayed on the display fixture 110.

FIG. 5 is a diagram schematically illustrating a configuration of a data record DRA included in the product management database 932.

The product management database 932 is a set of a plurality of data records DRA associated with the plurality of weighing scales 6, respectively. The data record DRA includes fields FA, FB, FC, and FD. In the field FA, a weighing scale ID for distinguishing the associated weighing scale 6 from the other weighing scales is set. In the field FB, a product code for distinguishing the product-sold-by-weight placed on the associated weighing scale 6 from the other products-sold-by-weight is set. The product code is an identification code defined for identifying a product-sold-by-weight for each stock keeping unit (SKU), and for example, a Japanese article number (JAN) code is used. In the field FC, the unit price per unit weight of the product-sold-by-weight identified by the product code set in the field FB is set. In the field FD, the previous measurement value by the associated weighing scale 6 is set. The data record DRA may include a field in which any data other than those described above is set.

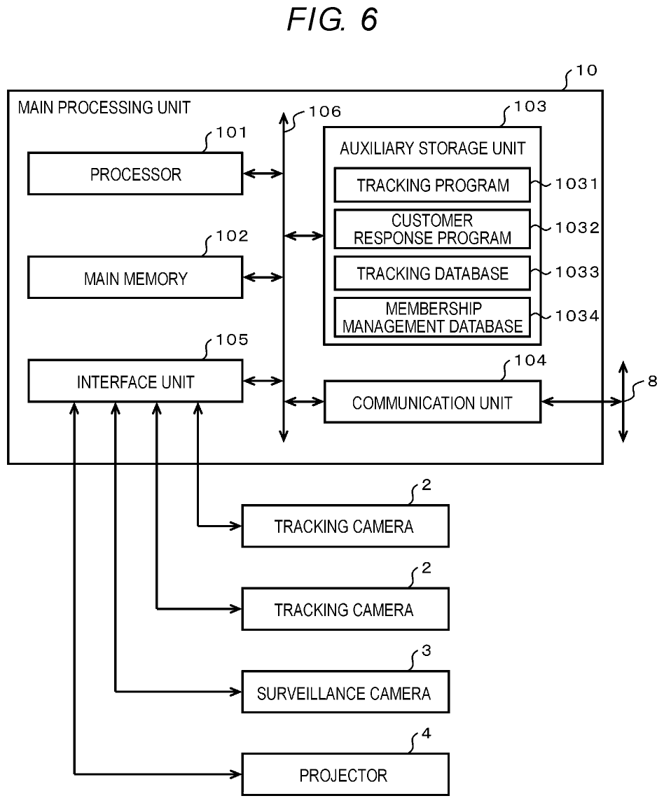

FIG. 6 is a block diagram illustrating a circuit configuration of a main part of the main processing unit 10. In FIG. 6, elements identical to those illustrated in FIGS. 1 and 2 are designated by the same reference numerals.

The main processing unit 10 includes a processor 101, a main memory 102, an auxiliary storage unit 103 (e.g., an auxiliary storage device, an auxiliary memory), a communication unit 104 (e.g., a communication device), an interface unit 105 (e.g., an interface device, a user interface), and a transmission line 106.

The processor 101, the main memory 102, the auxiliary storage unit 103, the communication unit 104, and the interface unit 105 can communicate with each other via the transmission line 106. A computer for controlling the main processing unit 10 is configured by connecting the processor 101, the main memory 102, and the auxiliary storage unit 103 with the transmission line 106.

The processor 101 corresponds to the central part of the computer. The processor 101 executes information processing for realizing various functions of the main processing unit 10 according to an operating system and an information processing program such as an application program. The processor 101 is a CPU, for example.

The main memory 102 corresponds to a main memory portion of the computer. The main memory 102 includes a non-volatile memory area and a volatile memory area. The main memory 102 stores the information processing program described above in the non-volatile memory area. The main memory 102 may store data necessary for the processor 101 to execute information processing in a non-volatile or volatile memory area. The main memory 102 uses the volatile memory area as a work area in which data is appropriately rewritten by the processor 101. The non-volatile memory area is a ROM, for example. The volatile memory area is a RAM, for example.

The auxiliary storage unit 103 corresponds to an auxiliary storage portion of the computer. For the auxiliary storage unit 103, a storage unit (e.g. a memory) using a well-known storage device such as EEPROM, HDD, SSD, and the like can be used. The auxiliary storage unit 103 stores data used by the processor 101 to perform various processes, data generated by the processes of the processor 101, and the like. The auxiliary storage unit 103 may store the information processing program described above.

The communication unit 104 is an interface for data communication via the communication path 8 in the fixture. For the communication unit 104, for example, a well-known communication device for performing data communication via a LAN can be used.

The two tracking cameras 2, the surveillance cameras 3, and the projector 4 are connected to the interface unit 105, respectively. The interface unit 105 interfaces the exchange of data between the processor 101, the tracking camera 2, the surveillance camera 3, and the projector 4. For the interface unit 105, a well-known device such as various interface boards such as a USB board can be used. A plurality of interface units 105 may be provided.

The transmission line 106 includes an address bus, a data bus, a control signal line, and the like, and transmits data and control signals exchanged between the connected units.

The auxiliary storage unit 103 stores a tracking program 1031 and a customer response program 1032, each of which is one of the information processing programs. The tracking program 1031 is an application program and describes information processing for tracking a person, which will be described below. The customer response program 1032 is an application program, and describes information processing for customer response, which will be described below. A portion of the storage area of the auxiliary storage unit 103 is used as a storage area of a tracking database 1033 and a membership management database 1034. The tracking database 1033 is a database for managing data for tracking a person to be tracked. The membership management database 1034 is a database for managing members being tracked.

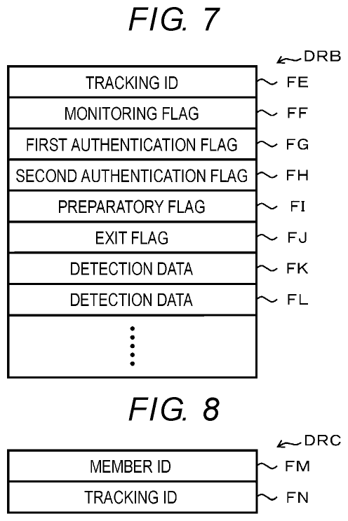

FIG. 7 is a diagram schematically illustrating a configuration of a data record DRB included in the tracking database 1033.

The tracking database 1033 is a set of data records DRB associated with each person as a target of tracking. The data record DRB includes fields FE, FF, FG, FH, FI, FJ, and FK. The data record DRB may include a field FL and following fields. In the field FE, a tracking ID is set, which is assigned to identify an associated person from the other people. The tracking ID is temporarily assigned to the person to be tracked, and is not the data for specifying an individual. In the field FF, a monitoring flag is set, which indicates whether or not the associated person is targeted for behavior monitoring. In at least one embodiment, when in ON state, the monitoring flag indicates that the behavior is to be monitored. In the field FG, a first authentication flag is set, which indicates whether or not an associated person is located in an authentication area corresponding to the first UI unit 5. In the field FH, a second authentication flag is set, which indicates whether or not an associated person is located in an authentication area corresponding to the second UI unit 5. In at least one embodiment, when in ON state, the first authentication flag and the second authentication flag indicate that a person is located in the authentication area. In the field FI, a preparatory flag is set, which indicates whether or not an associated person is located in the preparatory area which will be described below. In at least one embodiment, when in ON state, the preparatory flag indicates that a person is located in the preparatory area. In the field FJ, an exit flag is set, which indicates whether or not an associated person exits the tracking area which will be described below. In at least one embodiment, when in the ON state, the exit flag indicates exit of a person. In the field FK, detection data is set, which indicates a result of one position detection for an associated person. As the associated person moves along, the field FL and the following fields are sequentially added, in which detection data is set, indicating the result of position detections after the movement. The data record DRB may include a field in which any data other than those described above is set.

FIG. 8 is a diagram schematically illustrating a configuration of a data record DRC included in the membership management database 1034.

The membership management database 1034 is a set of data records DRC associated with each person who is a target of tracking and who is completed with member authentication. Therefore, the number of data records DRC included in the membership management database 1034 varies in response to the number of applicable people. In certain situations, the membership management database 1034 may not contain any data record DRC. The data record DRC includes fields FM and FN. In the field FM, a member ID is set, which is given in advance to the associated person. In the field FN, a tracking ID for tracking the associated person is set. The data record DRC may include a field in which any data other than those described above is set.

For the hardware of the product monitoring unit 9 or the main processing unit 10, for example, a general-purpose information processing device can be used. Then, the product monitoring unit 9 or the main processing unit 10 is generally transferred with the product monitoring program 931 or the tracking program 1031 and the customer response program 1032 stored in the auxiliary storage unit 93 or the auxiliary storage unit 103 respectively, and without the product management database 932 or the tracking database 1033 and the membership management database 1034 stored therein. However, hardware without the product monitoring program 931 or the tracking program 1031 and the customer response program 1032 stored in the auxiliary storage unit 93 or the auxiliary storage unit 103, or hardware having another version of application program of the same type stored in the auxiliary storage unit 93 or the auxiliary storage unit 103, may be transferred separately from the product monitoring program 931 or the tracking program 1031 and the customer response program 1032. Then, in response to an operation by any worker, the product monitoring program 931 or the tracking program 1031 and the customer response program 1032 may be written to the auxiliary storage unit 93 or the auxiliary storage unit 103 to configure the product monitoring unit 9 or the main processing unit 10. The transfer of the product monitoring program 931 or the tracking program 1031 and the customer response program 1032 to the auxiliary storage unit 93 or the auxiliary storage unit 103 can be performed by recording on a removable recording medium such as a magnetic disk, a magneto-optical disk, an optical disk, and a semiconductor memory, or by communication via a network. The product management database 932 or the tracking database 1033 and the membership management database 1034 are configured in the auxiliary storage unit 93 or the auxiliary storage unit 103 by the processor 91 or 101 executing information processing based on the product monitoring program 931 or the tracking program 1031 and the customer response program 1032. At least one of the product monitoring program 931 and the product management database 932 may be stored in the main memory 92. At least a portion of the tracking program 1031, customer response program 1032, tracking database 1033, and membership management database 1034 may be stored in the main memory 102.

Next, the operation of the store system 100 configured as described above will be described. The description of the processes provided below are examples, and it is possible to change the order of some processes, omit some processes, add another process, and the like as appropriate.

It is assumed that the display fixture 110 is used for unmanned sales by temporarily installing the product-sold-by-weight on display at a storefront or the like in a normal retail store. Therefore, the display fixture 110 is included the casters 12 and the handles 13 so as to be easily moved by a clerk or the like. However, the display fixture 110 may be installed at any place such as inside a company or the like, or may be permanently installed, and its use is not limited to the examples described above. If it is permanently installed, the casters 12 and the handles 13 may be omitted. Electrical elements included in the display fixture 110 may be operated by power supply from a commercial power source or the like using a power cable, or may be operated by power supply from a battery mounted on the display fixture 110.

In at least one embodiment, one product-sold-by-weight is to be displayed in the measurement area of one weighing scale 6 on the shelf board 11. Then, an administrator such as a clerk designates a product-sold-by-weight and a measurement area in which the product is to be displayed, by a predetermined operation on the UI unit 5. For example, the processor 53 displays a graphical user interface (GUI) screen for selecting a measurement area on the touch panel 51, and receives a designation of the measurement area by a touch on the GUI screen. Further, the processor 53 causes the reader 52 to read a product barcode illuminated by the administrator. Then, it is assumed that the processor 53 designates that the product-sold-by-weight identified by the product code represented by the product barcode read by the reader 52, is displayed in the designated measurement area. In response to this designation, the processor 53 in the UI unit 5 finds the data record DRA in which the weighing scale ID of the weighing scale 6 corresponding to the designated measurement area is set in the field FA, from the product management database 932, and sets a product code of the designated product-sold-by-weight in the field FB of the corresponding data record DRA. The processor 53 sets the unit price per unit weight designated in advance by the administrator in the field FC of the data record DRA in which the product code described above is set. At this time, the processor 53 acquires a measurement value of the weighing scale 6 corresponding to the corresponding measurement area, for example. The processor 53 may set the acquired measurement value described above in the field FD of the data record DRA, or may provisionally set a predetermined value such as 0.

It should be noted that the product management database 932 may be updated so as to match the display status of the product-sold-by-weight on the shelf board 11, and the update thereof may use any method. For example, in response to an instruction from any external sales support device, the processor 53 may update the product management database 932. Further, the processor 53 may access the sales management device 120 or any other server device via the communication unit 57, the communication path 8 in the fixture, and the communication network 140, and acquire the unit price per unit weight associated with the product code.

If the display fixture 110 is in an operating state for customer response, the processor 101 in the main processing unit 10 executes information processing according to the tracking program 1031 (hereinafter, referred to as tracking process).

Meanwhile, the tracking process is mainly a process of specifying a current position of a person as a target of tracking (hereinafter referred to as a person-to-track) in the tracking area, and confirming whether or not the corresponding position is located in an area of some areas within the tracking area that are defined relative to the display fixture 110. Therefore, prior to describing the tracking process, the area defined in the tracking area will be described.

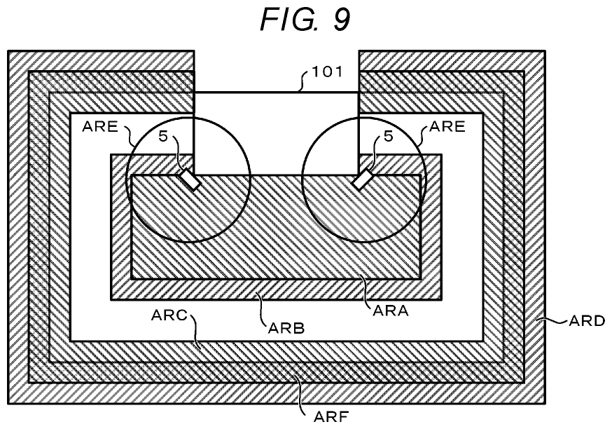

FIG. 9 is a plan view illustrating a state of areas set in the tracking area.

As illustrated in FIG. 9, the purchase area ARA, the detection area ARB, the preparatory area ARC, the confirm area ARD, and the two authentication areas ARE are logically defined with reference to the position of the display fixture 110, respectively. The rectangular area that includes the entire area of the confirm area ARD is the tracking area. The specific area type of each area may be freely determined by the developer of the tracking program 1031, for example. That is, the individual size of each area, the ratio of the sizes between the plurality of areas, and the like may be changed from the state illustrated in FIG. 9. Further, the size of each area and the like may be changed in response to an instruction from any operator such as a maintenance worker, a store manager, and the like. In this way, it is possible to adjust each area in consideration of the structure of the installation location of the display fixture 110 and the like.

The purchase area ARA is an area where a customer who wants to take out a product-sold-by-weight from the display fixture 110 should be located. The projector 4 projects an image such that the lines PL illustrated in FIG. 1 substantially coincide with the outer edges of the purchase area ARA. If the size of the purchase area ARA can be changed as described above, the projector 4 makes it possible to change the projection magnification of the image. Then, the projector 4 changes the projection magnification by an operation from the maintenance worker, the store manager, or the like described above, or in response to an instruction from the processor 101 of the main processing unit 10, for example. For example, a rule for using the service provided by the store system 100 may be such that the customer stays in the purchase area ARA while all the product-sold-by-weight to be purchased are took out from the shelf 1.

The detection area ARB is an area for newly detecting a person-to-track. The detection area ARB is defined as an area through which a person entering the purchase area ARA passes, for example. That is, the detection area ARB is a strip-shaped area around the purchase area ARA, for example. The detection area ARB may partially overlap with the purchase area ARA.

The preparatory area ARC and the confirm area ARD are areas for determining an exit of the person-to-track from the tracking area. Both the preparatory area ARC and the confirm area ARD are defined as areas through which a person exiting the purchase area ARA passes. In addition, the preparatory area ARC is closer to the purchase area ARA than the confirm area ARD. In the example of FIG. 9, a portion of the preparatory area ARC and a portion of the confirm area ARD overlap with each other. The overlapping area ARF is an area where the preparatory area ARC and the confirm area ARD overlap with each other. The preparatory area ARC and the confirm area ARD may be adjacent to each other without overlapping. Further, the preparatory area ARC may be separated from the confirm area ARD. However, a portion of the confirm area ARD and a portion of the preparatory area ARC may overlap with each other. Further, the confirm area ARD and the preparatory area ARC may be adjacent to each other without overlapping.

The two authentication areas ARE correspond to the two UI units 5, respectively, as described above. Hereinbelow, if it is necessary to distinguish between the two authentication areas ARE, the authentication area ARE corresponding to the first UI unit 5 is referred to as a first authentication area ARE, and the authentication area ARE corresponding to the second UI unit 5 is referred to as a second authentication area ARE. In the example of FIG. 9, the circular areas centered on the corresponding UI units 5 are designated as the authentication areas ARE.

A direction of image capturing and a size of the field of view of the two tracking cameras 2 are set so as to capture images of the capturing area including at least the tracking area either respectively or for their divided shares. Then, the processor 101 executes information processing (hereinafter, referred to as detection process) for determining the current position of the person based on the image captured by the tracking camera 2, separately from the tracking process described below. The processor 101 attempts to detect the person reflected in the image based on the image captured by the tracking camera 2, for example. Then, if the processor 101 can detect the person, the processor determines the position of the person. As a process of determining the position of the person reflected in the image from the image, various well-known processes can be appropriately used. If a camera device having a distance measurement function such as a TOF camera and a stereo camera is used as the tracking camera 2, the processor 101 may determine the current position of the person in consideration of the measurement result of this function. The processor 101 periodically executes the detection process at predetermined intervals.

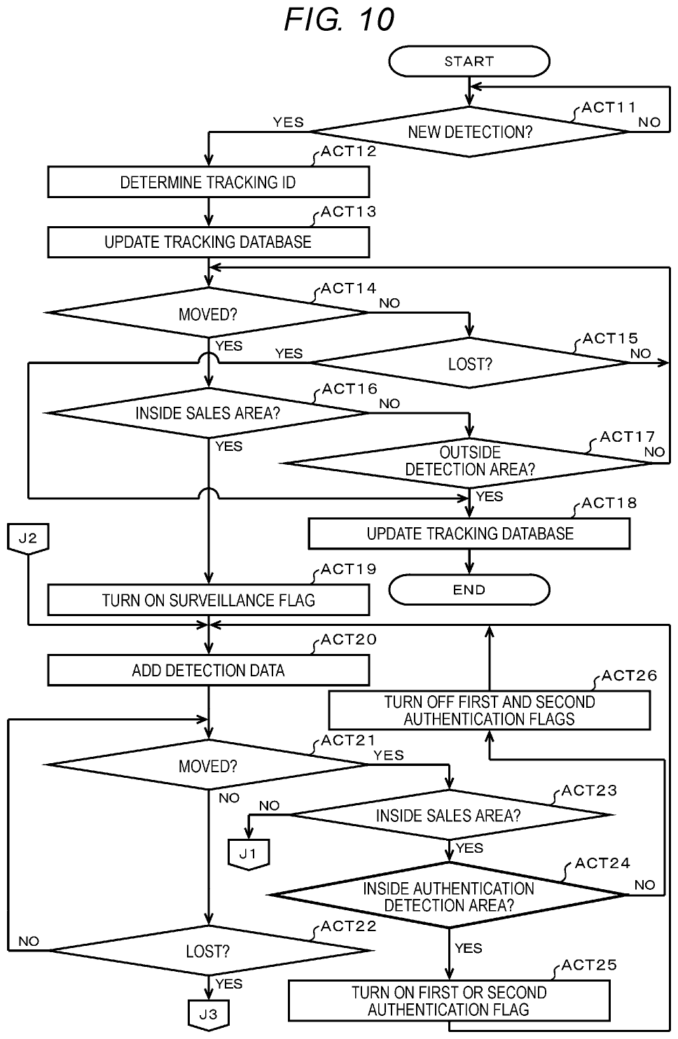

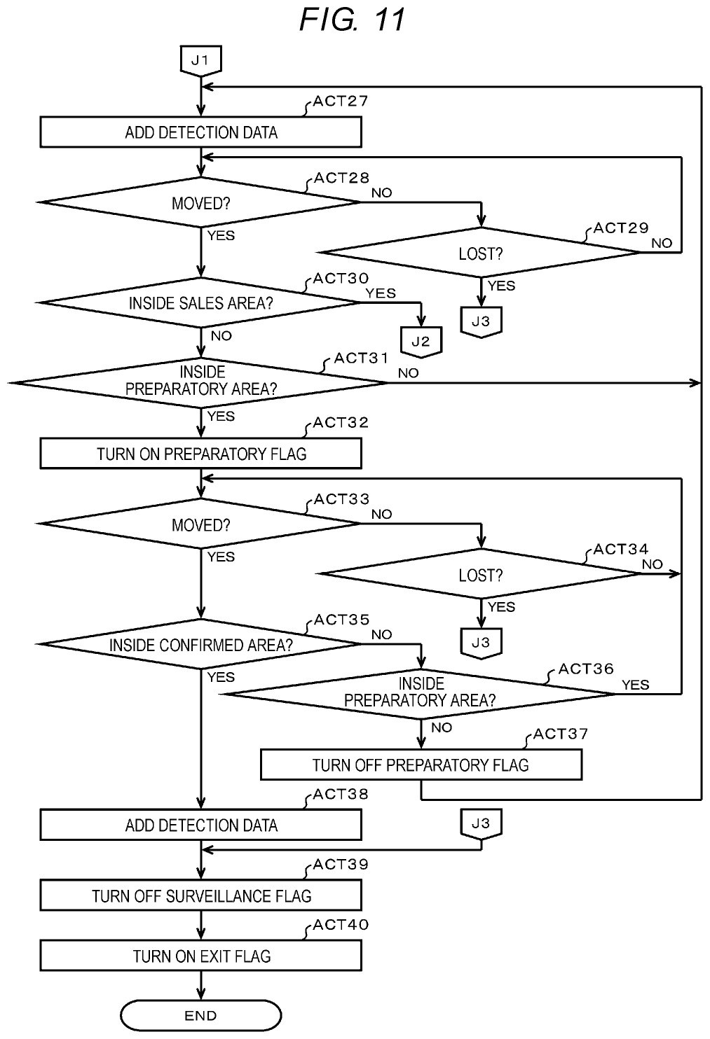

FIGS. 10 and 11 are flowcharts of the tracking process.

In ACT11 in FIG. 10, the processor 101 stands by for the detection of a new person as a target of tracking. For example, if a person who is not a target of tracking is detected as being located in the detection area by the detection process described above, the processor 101 determines YES and proceeds to ACT12. In addition, if the processor 101 proceeds to ACT12 as described above, the tracking process is continued and the tracking process is started in another thread. That is, in a situation where there are a plurality of people to be tracked, the tracking process is executed in parallel for each of those people. Then, if the person detected by the detection process as being located in the detection area is not the person-to-track in the other tracking process, the processor 101 determines that the person is not the target of tracking.

In ACT12, the processor 101 determines a tracking ID of the newly detected person so as not to overlap with a tracking ID of another person-to-track.

In ACT13, the processor 101 updates the tracking database 1033 to manage the newly detected person as the person-to-track. For example, the processor 101 adds a new data record DRB to the tracking database 1033. The processor 101 sets the tracking ID determined by ACT12 in the field FE of the corresponding new data record DRB. The processor 101 turns off all the flags of the fields FF through FJ of the corresponding new data record DRB. The processor 101 sets the detection data indicating the current position and current date and time as determined by the detection process for the newly detected person in the field FK of the corresponding new data record DRB. The processor 101 does not include the field FL and the following fields in the corresponding new data record DRB.

As a result, the newly detected person is set as a person-to-track. As described above, a plurality of tracking processes may be executed in parallel and there may be a plurality of people-to-track for the display fixture 110 at the same time, but if the term “person-to-track” is simply used in the following description, it refers to a person or people-to-track who is or are the target of the tracking process in the description.

In ACT14, the processor 101 confirms whether or not the person-to-track has moved. Then, if the movement of the person-to-track cannot be confirmed, the processor 101 determines NO and proceeds to ACT15.

In ACT15, the processor 101 confirms whether or not the person-to-track is lost. Then, when tracking of the person-to-track is continued, then the processor 101 determines NO and returns to ACT14.

Thus, in ACT14 and ACT15, the processor 101 stands by for the person-to-track to move or be lost.

For example, each time the result of the detection process is newly obtained, the processor 101 specifies a person-to-track from among the newly detected people based on the current position of the newly detected person and the position indicated in the detection data that is set in the data record DRB associated with the person-to-track. Then, the processor 101 determines whether or not the person-to-track has moved based on the relationship between the current position of the person-to-track and the position indicated by the detection data that is set at the end of the data record DRB associated with the person-to-track. For example, if a distance between the two positions described above is equal to or greater than a predetermined threshold value, the processor 101 determines that the person-to-track has moved. Then, if the person-to-track has moved, the processor 101 determines YES at ACT14 and proceeds to ACT16.

In ACT16, the processor 101 confirms whether or not the current position of the person-to-track is inside the purchase area ARA. Then, if the current position of the person-to-track is outside the purchase area ARA, the processor 101 determines NO and proceeds to ACT17.

In ACT17, the processor 101 confirms whether or not the current position of the person-to-track is outside the detection area ARB. Then, if the current position of the person-to-track is inside the detection area ARB, the processor 101 determines NO and returns to ACT14.

Thus, in ACT14 through ACT17, the processor 101 stands by for the person-to-track to move into the purchase area ARA or to move in a direction opposite to the purchase area ARA and exit the detection area ARB.

If the person-to-track exits the detection area ARB without entering the purchase area ARA, the processor 101 determines YES at ACT17 and proceeds to ACT18.

Meanwhile, the processor 101 deems it lost in a case if the data record DRB associated with the person-to-track in the tracking database 1033 is not updated over a predetermined period of time, for example. Then, if the person is lost during the standby state of ACT14 and ACT15, the processor 101 determines YES at ACT15 and accordingly proceeds to ACT18.

In ACT18, the processor 101 updates the tracking database 1033 to exclude this person-to-track from the person-to-track. For example, the processor 101 deletes the data record DRB in which the tracking ID of the person-to-track is set in the field FE, from the tracking database 1033. Then, the processor 101 ends the tracking process with this.

A person who intends to purchase the product-sold-by-weight displayed on the display fixture 110 will pass through the detection area ARB and proceed to the purchase area ARA. If the person-to-track moves in that way, the processor 101 determines YES at ACT16 and proceeds to ACT19.

In ACT19, the processor 101 turns on the monitoring flag set in the field FF of the data record DRB in which the tracking ID of the person-to-track is set in the field FE.

In ACT20, the processor 101 adds a field in which new detection data is set to the end of the data record DRB in which the tracking ID of the person-to-track is set in the field FE. The processor 101 uses the new detection data as data indicating the current position and current time of the person-to-track as determined by the latest detection process. In this way, by adding the detection data according to the movement of the person-to-track, the movement trajectory of the person-to-track is recorded.

In ACT21, the processor 101 confirms whether or not the person-to-track has moved. Then, if the movement of the person-to-track cannot be confirmed, the processor 101 determines NO and proceeds to ACT22.

In ACT22, the processor 101 confirms whether or not the person-to-track is lost. Then, when tracking of the person-to-track is continued, then the processor 101 determines NO and returns to ACT21.

Thus, in ACT21 and ACT22, the processor 101 stands by for the person-to-track to move or be lost. Then, if the processor 101 confirms that the person-to-track has moved in the same manner as in ACT14, the processor determines YES at ACT21 and proceeds to ACT23.

In ACT23, the processor 101 confirms whether or not the current position of the person-to-track is inside the purchase area ARA. Then, if the current position of the person-to-track is inside the purchase area ARA, the processor 101 determines YES and proceeds to ACT24.

In ACT24, the processor 101 confirms whether or not the current position of the person-to-track is inside the first or second authentication area ARE. Then, if the current position of the person-to-track is inside the first or second authentication area ARE, the processor 101 determines YES and proceeds to ACT25. That is, if the person-to-track is located in the area where the purchase area ARA and the first or second authentication area ARE overlap with each other, the processor 101 proceeds to ACT25.

In ACT25, if the person-to-track is located in the first authentication area, the processor 101 turns on the first authentication flag, and if the person-to-track is located in the second authentication area, the processor 101 turns on the second authentication flag. Then, the processor 101 returns to ACT20, adds the detection data regarding the position of the person-to-track after the movement, and then returns to the standby state of ACT21.

If the current position of the person-to-track is inside the purchase area ARA, but outside the first or second authentication area ARE, the processor 101 determines NO at ACT24 and proceeds to ACT26.

In ACT26, the processor 101 turns off both the first authentication flag and the second authentication flag. Then, the processor 101 returns to ACT20, adds the detection data regarding the position of the person-to-track after the movement, and then returns to the standby state of ACT21.

If the person-to-track exits the purchase area ARA, the processor 101 determines NO at ACT23 and proceeds to ACT27 in FIG. 11.

In ACT27, the processor 101 adds a field in which the detection data is set, as in ACT20. That is, the processor 101 adds new detection data to the data record DRB associated with the person-to-track in order to record the movement of the person-to-track.

In ACT28, the processor 101 confirms whether or not the person-to-track has moved. Then, if the movement of the person-to-track cannot be confirmed, the processor 101 determines NO and proceeds to ACT29.

In ACT29, the processor 101 confirms whether or not the person-to-track is lost. Then, when tracking of the person-to-track is continued, then the processor 101 determines NO and returns to ACT28.

Thus, in ACT28 and ACT29, the processor 101 stands by for the person-to-track to move or be lost. Then, if the processor 101 confirms that the person-to-track has moved in the same manner as in ACT14, it determines YES at ACT28 and proceeds to ACT30.

In ACT30, the processor 101 confirms whether or not the current position of the person-to-track is inside the purchase area ARA. Then, if the current position of the person-to-track is inside the purchase area ARA, the processor 101 determines YES and returns to ACT20 in FIG. 10. That is, if the person-to-track returns to the purchase area ARA, the processor 101 adds new detection data in order to record the above movement of the person-to-track and shifts to the standby state of ACT21 and ACT22.

If the person-to-track does not return to the purchase area ARA, the processor 101 determines NO at ACT30 in FIG. 11 and proceeds to ACT31.

In ACT31, the processor 101 confirms whether or not the current position of the person-to-track is inside the preparatory area ARC. Then, if the current position of the person-to-track is outside the preparatory area ARC, the processor 101 determines NO and proceeds to ACT27. That is, the processor 101 adds new detection data in order to record the movement of the person-to-track and returns to the standby state of ACT28 and ACT29.

If the person-to-track exits the purchase area ARA and moves into the preparatory area ARC without returning to the purchase area ARA, the processor 101 determines YES at ACT31 and proceeds to ACT32.

In ACT32, the processor 101 turns on the preparatory flag set in the field FI of the data record DRB in which the tracking ID of the person-to-track is set in the field FE.

In ACT33, the processor 101 confirms whether or not the person-to-track has moved. Then, if the movement of the person-to-track cannot be confirmed, the processor 101 determines NO and proceeds to ACT34.

In ACT34, the processor 101 confirms whether or not the person-to-track is lost. Then, when tracking of the person-to-track is continued, then the processor 101 determines NO and returns to ACT33.

Thus, in ACT33 and ACT34, the processor 101 stands by for the person-to-track to move or be lost. Then, if the processor 101 confirms that the person-to-track has moved in the same manner as in ACT14, the processor determines YES at ACT33 and proceeds to ACT35.

In ACT35, the processor 101 confirms whether or not the current position of the person-to-track is inside the confirm area ARD. Then, if the current position of the person-to-track is outside the confirm area ARD, the processor 101 determines NO and proceeds to the ACT36.

In ACT36, the processor 101 confirms whether or not the current position of the person-to-track is inside the preparatory area ARC. Then, if the current position of the person-to-track is inside the preparatory area ARC, the processor 101 determines YES and returns to ACT33.

Thus, in ACT33 to ACT36, the processor 101 stands by for the person-to-track to move into the confirm area ARD, move in the direction opposite to the confirm area ARD and exit the preparatory area ARC or be lost.

If the person-to-track exits the preparatory area ARC without entering the confirm area ARD, the processor 101 determines NO at ACT36 and proceeds to ACT37.

In ACT37, the processor 101 turns off the preparatory flag set in the field FI of the data record DRB in which the tracking ID of the person-to-track is set in the field FE. Then, the processor 101 returns to ACT27, that is, the processor 101 adds new detection data in order to record the movement of the person-to-track and then shifts to the standby state of ACT28 and ACT29.

If the person-to-track passes through the preparatory area ARC and proceeds to the confirm area ARD in order to move away from the display fixture 110, the processor 101 determines YES at ACT35 and proceeds to ACT38.

In ACT38, the processor 101 adds a field in which the detection data is set, as in ACT20. That is, the processor 101 adds new detection data to the data record DRB associated with the person-to-track in order to record the movement of the person-to-track. Then, the processor 101 proceeds to ACT39.

If the processor 101 confirms that the tracking of the person-to-track is lost in any of the standby states of ACT21 and ACT22 in FIG. 10, the standby states of ACT28 and ACT29 in FIG. 11, and the standby states of ACT33 and ACT34 in FIG. 11, the processor determines YES in ACT22, ACT29 or ACT34, and proceeds to ACT39 in FIG. 11.

In ACT39, the processor 101 turns off the monitoring flag set in the field FF of the data record DRB in which the tracking ID of the person-to-track is set in the field FE.

In ACT40, the processor 101 turns on the exit flag set in the field FJ of the data record DRB in which the tracking ID of the person-to-track is set in the field FE. Then, the processor 101 ends the tracking process with this.

If the processor 101 executes the tracking process as described above, it is possible to confirm the area in which each of the people-to-track is located and also the movement trajectory, based on the tracking database 1033. The processor 101 also detects that the person-to-track has left the shelf 1 based on the results of such tracking.

Meanwhile, if the display fixture 110 is in an operating state for customer response, the processor 91 in the product monitoring unit 9 executes information processing according to the product monitoring program 931 (hereinafter, referred to as monitoring process). The monitoring process is information processing for monitoring the take-out of the product-sold-by-weight displayed on the display fixture 110.

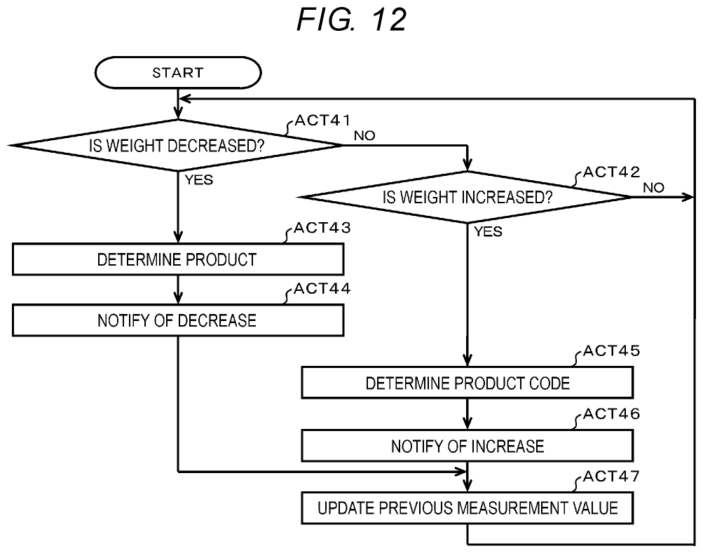

FIG. 12 is a flowchart of the monitoring process.

In ACT41, the processor 91 confirms whether or not the weight of the product-sold-by-weight displayed on the display fixture 110 is decreased. Then, if the corresponding event cannot be confirmed, the processor 91 determines NO and proceeds to ACT42.

In ACT42, the processor 91 confirms whether or not the weight of the product-sold-by-weight displayed on the display fixture 110 is increased. Then, if the corresponding event cannot be confirmed, the processor 91 determines NO and returns to ACT41.

Thus, in ACT41 and ACT42, the processor 91 stands by for the weight of the product-sold-by-weight to decrease or increase.

If a customer takes out the product-sold-by-weight displayed on the display fixture 110 from the display fixture 110 with a take-out tool such as tongs or a ladle, the weight of the product-sold-by-weight displayed on the display fixture 110 is decreased. Then, in this case, the measurement value obtained by the weighing scale 6 in the measurement area where the corresponding product-sold-by-weight is placed decreases. Further, if the product-sold-by-weight once taken out from the display fixture 110 is returned to the display fixture 110, the weight of the product-sold-by-weight displayed on the display fixture 110 increases. Then, in this case, the measurement value obtained by the weighing scale 6 in the measurement area where the corresponding product-sold-by-weight is placed increases.

If the measurement value of any of the weighing scales 6 decreases, the processor 91 determines YES at ACT41 and proceeds to ACT43. For example, if the measurement value acquired from the weighing scale 6 is smaller than the previous measurement value set in the field FD of the data record DRA associated with the same weighing scale 6 in the product management database 932, and a difference value is equal to or greater than a specified value, the processor 91 determines a decrease in the measurement value of the weight scale 6.

In ACT43, the processor 91 determines the product-sold-by-weight for which weight has decreased. For example, the processor 91 finds the data record DRA in which the weighing scale ID of the weighing scale 6 measuring the decrease in the measurement value as described above is set in the field FA, from the product management database 932. Then, the processor 91 determines the product-sold-by-weight for which weight has decreased with a product-sold-by-weight identified by the product code set in the field FB of the corresponding data record DRA.

In ACT44, the processor 91 notifies the main processing unit 10 of a decrease in the product-sold-by-weight. For example, the processor 91 transmits notification data for notifying the decrease in the product-sold-by-weight from the communication unit 94 to the communication path 8 in the fixture toward the main processing unit 10. The processor 91 includes identification data for identifying the notification of the decrease, the product code of the product-sold-by-weight for which weight has decreased, and the decreased measurement value (decrease amount) in the notification data described above.

On the other hand, if the measurement value of any of the weighing scales 6 increases, the processor 91 determines YES at ACT42 and proceeds to ACT45. For example, if the measurement value acquired from the weighing scale 6 is greater than the previous measurement value set in the field FD of the data record DRA associated with the same weighing scale 6 in the product management database 932, and the difference value is equal to or greater than the specified value, the processor 91 determines that the measurement value of the weight scale 6 has increased.

In ACT45, the processor 91 determines a product-sold-by-weight for which weight has increased. For example, the processor 91 finds out the data record DRA in which the weighing scale ID of the weighing scale 6 measuring the increased measurement value as described above is set in the field FA, from the product management database 932. Then, the processor 91 determines the product-sold-by-weight for which weight has increased with a product-sold-by-weight identified by the product code set in the field FB of the corresponding data record DRA.

In ACT46, the processor 91 notifies the main processing unit 10 of the increase in the product-sold-by-weight. For example, the processor 91 transmits notification data for notifying the increase of product-sold-by-weight from the communication unit 94 to the communication path 8 in the fixture toward the main processing unit 10. The processor 91 includes identification data for identifying the notification of the increase, the product code of the product-sold-by-weight for which weight has increased, and the increased measurement value (increase amount) in the notification data described above.

If the processor 91 finishes the notification at ACT44 or ACT46, the processor proceeds to ACT47 in either case.

In ACT47, the processor 91 updates the previous measurement value set in the field FD of the data record DRA associated with the weighing scale 6 of which measurement value has changed in the product management database 932 as the measurement value after change. Then, the processor 91 returns to the standby state of ACT41 and ACT42.

If the display fixture 110 is in an operating state for customer response, the processor 101 in the main processing unit 10 executes information processing according to the customer response program 1032 (hereinafter, referred to as customer response process), in addition to the detection process and the tracking process described above.

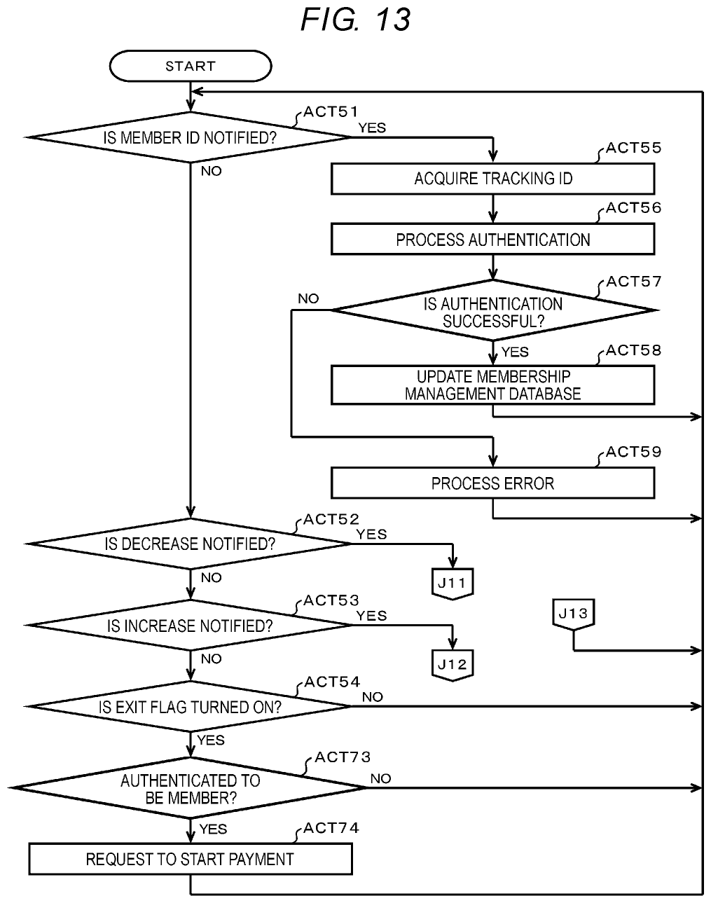

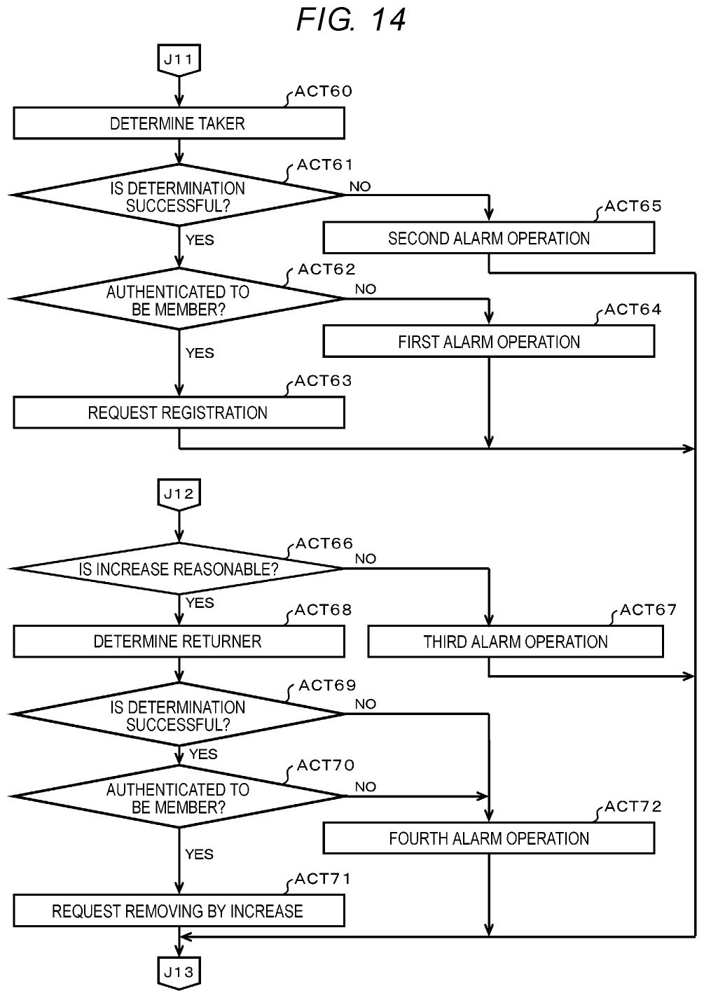

FIGS. 13 and 14 are flowcharts of the customer response process.

In ACT51 in FIG. 13, the processor 101 confirms whether or not the member ID is notified. Then, if the corresponding notification cannot be confirmed, the processor 101 determines NO and proceeds to ACT52.

In ACT52, the processor 101 confirms whether or not the decrease notification is performed. Then, if the corresponding notification cannot be confirmed, the processor 101 determines NO and proceeds to ACT53.

In ACT53, the processor 101 confirms whether or not the increase notification is performed. Then, if the corresponding notification cannot be confirmed, the processor 101 determines NO and proceeds to ACT54.

In ACT54, the processor 101 confirms whether or not the exit flag is turned on. Then, if the corresponding event cannot be confirmed, the processor 101 determines NO and returns to ACT51.

Thus, in ACT51 to ACT54, the processor 101 stands by for the member ID, decrease or increase to be notified, or for the exit flag to be turned on.

Meanwhile, a member ID for distinguishing from the other customers is given to the customer who is completed with the member registration. In addition, a customer who is registered as a member can register payment information for payment with a payment method that does not involve the exchange of cash. In addition, various personal information, member ID and payment information about the customer registered as a member are managed by the sales management device 120 or the payment device 130, or managed by another member server.

If a customer who is registered as a member wants to make a payment for the purchase of the product-sold-by-weight displayed on the display fixture 110 using the registered payment information, the customer reads the member ID to the UI unit 5. For example, the customer makes a display device of a mobile information terminal carried by the customer display a barcode indicating the member ID, and reads the barcode to the reader 52 of the UI unit 5. Any other method of reading the member ID to the UI unit 5 may be used.

If the member ID is read by the reader 52, the processor 53 in the UI unit 5 notifies the main processing unit 10 of the member ID by information processing based on the UI program 551. For example, the processor 53 transmits notification data including the identification data for identifying the notification of the member ID and the member ID from the communication unit 57 to the communication path 8 in the fixture toward the main processing unit 10.

For example, if the customer is required to have the member ID face straight the UI unit 5 so as to read it to the UI unit 5, by appropriately sizing the authentication area ARE, it is prevented that the same authentication flag is turned on for a plurality of people-to-track if the member ID is read by the UI unit 5. However, the processor 53 may specify a person-to-track who motions to get his or her member ID read, based on an image captured by the surveillance camera 3 or an image captured by another TOF camera or the like, for example, and notify the tracking ID of the person-to-track.

If the notification data for notification of the member ID is received by the communication unit 104, the processor 101 in the main processing unit 10 determines YES at ACT51 and proceeds to ACT55.

In ACT55, the processor 101 acquires the tracking ID of the person-to-track which corresponds to the customer who read the notified member ID to the UI unit 5. For example, if the member ID is notified from the first UI unit 5, the processor 101 finds the data record DRB in which the first authentication flag is turned on, from the tracking database 1033. Further, if the member ID is notified from the second UI unit 5, the processor 101 finds the data record DRB in which the second authentication flag is turned on, from the tracking database 1033. Then, the processor 101 acquires the tracking ID set in the field FE of the corresponding data record DRB. When finding a plurality of data records DRB in which the authentication flag are turned on corresponding to the UI unit 5 that notified the member ID, the processor 101 selects one data record DRB according to a predetermined rule. For example, the processor 101 selects the data record DRB of which position indicated by the detection data set in the field at the end is closer to the center of the authentication area.

In ACT56, the processor 101 executes authentication process for the notified member ID. For example, the processor 101 inquires of a device that monitors various personal information, member ID, and payment information about a customer registered as a member, and confirms that the notified member ID is a legitimate member ID given to the member.

In ACT57, the processor 101 confirms whether or not the authentication described above is successful. Then, if the authentication is successful, the processor 101 determines YES and proceeds to ACT58.

In ACT58, the processor 101 updates the membership management database 1034 so as to include data record DRC for managing the member whose member ID is read by the UI unit 5. That is, for example, the processor 101 sets the notified member ID in the field FM, and adds a new data record DRC in which the tracking ID acquired by ACT55 is set in the field FN, to the membership management database 1034. Then, the processor 101 returns to the standby state of ACT51 through ACT54.

Thus, the processor 101 identifies the person-to-track as a member identified by the notified member ID. The member is an individual specified by the membership registration. That is, the processor 101 identifies an individual as a person-to-track.

At ACT56, if authentication fails, the processor 101 determines NO in the ACT57 and proceeds to the ACT59.

In ACT59, the processor 101 executes error process. The error process is a process for notifying the customer of a failed authentication. For example, the processor 101 instructs the UI unit 5 that read the member ID to display a predetermined error screen for notifying the customer of the failed authentication. Alternatively, the processor 101 instructs the mobile information terminal displaying the barcode indicating the member ID to display the above error screen, for example. Then, the processor 101 returns to the standby state of ACT51 to ACT54.

If the notification data for the decrease notification described above is received by the communication unit 104, the processor 101 determines YES at ACT52 and proceeds to ACT60 in FIG. 14.

In ACT60, the processor 101 determines a taker who took out the product-sold-by-weight for which weight has decreased from the display fixture 110 with the take-out tool. For example, the processor 101 extracts all the data records DRB in which the monitoring flag set in the field FF is turned on from the tracking database 1033, and selects, as the candidates for the taker, the people-to-track as identified by the tracking IDs set in the field FE of the corresponding data records DRB. If a customer takes out a product-sold-by-weight from the display fixture 110 with a take-out tool, the customer extends his or her arm to the take-out tool for taking the corresponding product-sold-by-weight, picks up the product-sold-by-weight using the take-out tool, and then pulls his or her arm to put the product-sold-by-weight in a take-out container. Therefore, for example, the processor 101 specifies the person-to-track who performed the actions described above from among the people-to-track who are the candidates for the taker, based on the image captured by the surveillance camera 3, and determines the corresponding person-to-track as the taker.

More specifically, for example, the processor 101 analyzes changes in a plurality of images captured by the surveillance camera 3 during a monitoring period predetermined in consideration of the period during which the actions described above for taking the product-sold-by-weight are performed, to specify the person who performed the actions described above, and further determine the position of the person. The processor 101 selects, from the extracted data records DRB described above, a data record DRB in which the detection data set in the field at the end shows the closest position to the specified position described above. Then, if a distance between the position shown in the detection data set in the field at the end of the corresponding data record DRB and the specified position described above is shorter than a specified distance, the processor 101 determines that a person-to-track identified by the tracking ID set in the field FE of the corresponding data record DRB is the taker. If the corresponding person-to-track is not found, the processor 101 determines that the taker is unknown. The processor 101 may measure the length of the arm of the taker, based on the relationship between the position shown in the detection data set in the field at the end in the selected data record DRB described above and the displaying position of the product-sold-by-weight for which weight has decreased, and the image captured by the surveillance camera 3, and determine that the taker is unknown if the length is longer than a specified length.

In many cases, if the arm is pulled, the product-sold-by-weight is taken out, and the measurement value of the weighing scale 6 is changed. However, since it takes some time for the measurement value of the weighing scale 6 to stabilize because of the vibration of the shelf board 11, and the like, there is a time lag before the weighing scale 6 outputs a new measurement value. That is, by the time if the processor 101 receives the decrease notification, the action of the taker to take out the product-sold-by-weight is almost finished. That is, the monitoring period described above starts before the processor 101 receives the decrease notification. Therefore, for example, the processor 101 buffers the images captured by the surveillance camera 3 in the auxiliary storage unit 103 or the like for a certain period of time. Then, after receiving the decrease notification, the processor 101 analyzes the image related to the monitoring period among the buffered images. Alternatively, the process in ACT60 may be executed by the processor 101 as a process of a thread different from the customer response process.

In ACT61, the processor 101 confirms whether or not the determination of the taker is successful. Then, if the taker can be determined, the processor 101 determines YES and proceeds to ACT62.

In ACT62, the processor 101 confirms whether or not the person-to-track determined as the taker is an authenticated member. The processor 101 searches the membership management database 1034 for data record DRC in which the same tracking ID as that set in the field FE of the data record DRB selected at ACT60 is set in the field FN. Then, if the corresponding data record DRC is found, the processor 101 determines YES and proceeds to ACT63.

In ACT63, the processor 101 requests the sales management device 120 to register for the sale of the product-sold-by-weight for which weight has decreased. For example, the processor 101 transmits the request data for the corresponding request from the communication unit 104 to the communication path 8 in the fixture toward the sales management device 120. Then, the corresponding request data is relayed by the communication unit 7 and transmitted to the sales management device 120 via the communication network 140. The processor 101 includes the identification data for identifying the registration request, the product code of the product-sold-by-weight for which weight has decreased, the decreased measurement value, and the member ID in the request data described above. The processor 101 includes the product code included in the received notification data described above as it is in the request data as the product code of the product-sold-by-weight for which weight has decreased. The processor 101 includes the decreased measurement value included in the received notification data described above as it is in the request data as the decreased measurement value. The processor 101 includes the member ID set in the field FM of the data record DRC found at ACT62 in the request data.

When receiving the request data described above, the sales management device 120 performs a registration process for registering the product-sold-by-weight identified by the product code included in the request data as a product-sold-by-weight to be sold to the member identified by the member ID included in the request data, by the decreased measurement value included in the request data. The corresponding registration process may be the same process as that performed by an existing transaction processing device such as a POS terminal.

At ACT62, if the processor 101 confirms that the member is not the authenticated one, the processor 101 determines NO and proceeds to ACT64. For example, if the data record DRC in which the same tracking ID as that set in the field FE of the data record DRB selected at ACT60 is set in the field FN cannot be found from the membership management database 1034, the processor 101 determines that the member is not the authenticated one.

In ACT64, the processor 101 performs a first alarm operation. The first alarm operation is an operation for urging the taker to pay for the product-sold-by-weight taken out from the display fixture 110. As the first alarm operation, the processor 101 instructs the UI unit 5 to display a predetermined screen, for example. As the first alarm operation, the processor 101 instructs the UI unit 5 to output a predetermined voice message, for example. As the first alarm operation, the processor 101 may perform any operation other than those described above, or may perform a plurality of types of operations. Contents such as screens or voice messages may be appropriately determined according to the circumstances of the store where the display fixture 110 is installed. In the case of a store where there is a check-out corner where a clerk is stationed or a self-service-type check-out corner installed, for example, the content urges the taker to make a payment at the check-out corner. Further, in the case of a store where the purchase of the product-sold-by-weight displayed on the display fixture 110 is limited to members only, for example, the content urges the taker to return the product-sold-by-weight to the clerk. By this first alarm operation, if a customer who does not understand the service provided by the store system 100 takes out a product-sold-by-weight from the shelf 1, it is possible to allow the customer to appropriately perform the subsequent action.

If customers other than members are allowed to pay the product-sold-by-weight displayed on the display fixture 110 at the check-out corner where the clerk is stationed or at the self-service-type check-out corner, the fact that the person-to-track who is not completed with the member authentication took out the product-sold-by-weight from the shelf 1 does not correspond to an abnormal state.

Therefore, the first alarm operation in this case is not an alarm for the abnormal state. In the case of a store where the purchase of the product-sold-by-weight displayed on the display fixture 110 is limited to members only, the fact that a person-to-track who is not completed with the member authentication takes out the product-sold-by-weight from the shelf 1 corresponds to the abnormal state. Therefore, the first alarm operation in this case corresponds to the alarm with respect to an abnormal state.

At ACT60, if the taker cannot be determined, the processor 101 determines NO at ACT61 and proceeds to ACT65. This case corresponds to a case in which the processor 101 determines that the taker is unknown as described above at ACT60. In addition, this case corresponds to a case in which a person who is not tracked by the tracking process due to certain errors takes out the product-sold-by-weight.

In ACT65, the processor 101 performs a second alarm operation. The second alarm operation may be the same operation as the first alarm operation. However, the content of the second alarm operation is different from that of the first alarm operation. For example, the content in the second alarm operation is content that urges the taker or a person staying in the vicinity to consult with a clerk, for example. Alternatively, the second alarm operation may be an instruction to a terminal device used by the clerk to display a screen or output a voice message. The content in the second alarm operation in this case is content that urging the clerk to confirm the situation and deal with it, for example. Since the customer does not know whether or not he or she is correctly tracked by the tracking process, the abnormal state caused by the corresponding customer taking out the product-sold-by-weight from the shelf 1 is not the responsibility of the customer and the customer will not be able to comprehend the cause of the abnormality. The customer consults with the clerk in accordance with the second alarm and the clerk appropriately deals with the abnormal state so that the corresponding customer can resolve the abnormal state.

If ACT63, ACT64 or ACT65 are finished, the processor 101 returns to the standby state of ACT51 to ACT54 in FIG. 13.

If the notification data for the increase notification described above is received by the communication unit 104, the processor 101 determines YES at ACT53 in FIG. 13 and proceeds to ACT66 in FIG. 14.

In ACT66, the processor 101 confirms whether or not the increase in the weight of the product-sold-by-weight is reasonable. There may be a case if the customer returns a product-sold-by-weight once taken out of the display fixture 110 to a container that contains a different product-sold-by-weight in the display fixture 110. In this case, the weight of the different product-sold-by-weight increases, but such an increase in weight is not reasonable. That is, while the previous measurement value is not decreased, if the measurement value in an increasing direction is acquired from the weighing scale 6, the processor 101 determines it to be unreasonable. Further, there may be a case if the customer returns a different product together while returning a product-sold-by-weight once taken out from the display fixture 110 to the same container. In this case as well, the weight of the product-sold-by-weight increases, but such an increase in weight is also not reasonable. That is, if the measurement value in the increase direction greater than the measurement value decreased last time is acquired, the processor 101 determines it to be unreasonable.

At ACT66, if it is confirmed that the increase in the weight of the product-sold-by-weight is not reasonable, the processor 101 determines NO and proceeds to ACT67. In ACT67, the processor 101 performs a third alarm operation. The third alarm operation is an operation for notifying a clerk or the like of an unreasonable return operation performed on a product-sold-by-weight and for urging him or her to respond to the operation. As the third alarm operation, the processor 101 instructs the terminal device used by the clerk to display a screen or output a voice message, for example. As the third alarm operation, the processor 101 may perform any operation other than the above, or may perform a plurality of types of operations. Contents such as screens or voice messages may be appropriately determined according to the circumstances of the store where the display fixture 110 is installed.

At ACT66, if it is confirmed that the increase in the weight of the product-sold-by-weight is reasonable, the processor 101 determines YES and proceeds to ACT68.

In ACT68, the processor 101 determines a returner who returns the product-sold-by-weight to the display fixture 110. For example, the processor 101 extracts all the data records DRB in which the monitoring flag set in the field FF is turned on from the tracking database 1033, and selects, as the candidates for the returner, the people-to-track as identified by the tracking IDs set in the field FE of the corresponding data records DRB. When returning a product-sold-by-weight to the display fixture 110, the customer extends his or her arm to the take-out tool for returning the product-sold-by-weight, returns the product-sold-by-weight using the take-out tool, and then releases the take-out tool and pulls his arm. Therefore, for example, the processor 101 specifies the person-to-track who performed the actions described above from among the people-to-track who are the candidates for the returner, based on the image captured by the surveillance camera 3, and determines the corresponding person-to-track as the returner.

More specifically, for example, the processor 101 analyzes changes in a plurality of images captured by the surveillance camera 3 during a monitoring period predetermined in consideration of the period during which the actions described above for returning the product-sold-by-weight are performed, to specify the person who performed the actions described above, and further determine the position of the person. The processor 101 selects, from the extracted data records DRB described above, a data record DRB in which the detection data set in the field at the end shows the closest position to the specified position described above. Then, if a distance between the position shown in the detection data set in the field at the end of the corresponding data record DRB and the specified position described above is shorter than a specified distance, the processor 101 determines that a person-to-track identified by the tracking ID set in the field FE of the corresponding data record DRB is the returner. If the corresponding person-to-track is not found, the processor 101 determines that the returner is unknown. The processor 101 may measure the length of the arm of the returner, based on the relationship between the position shown in the detection data set in the field at the end in the selected data record DRB described above and the displaying position of the product-sold-by-weight for which weight has increased, and the image captured by the surveillance camera 3, and determine that the returner is unknown if the length is longer than a specified length.

If the product-sold-by-weight is returned, the monitoring period described above starts before the processor 101 receives the increase notification, as in the case in which the product-sold-by-weight is taken out. Therefore, for example, the processor 101 buffers the images captured by the surveillance camera 3 in the auxiliary storage unit 103 or the like for a certain period of time. Then, after receiving the increase notification, the processor 101 analyzes the image related to the monitoring period among the buffered images. Alternatively, the process in ACT68 may be executed by the processor 101 as a process of a thread different from the customer response process.

In ACT69, the processor 101 confirms whether or not the determination of the returner is successful. Then, if the returner can be determined, the processor 101 determines YES and proceeds to ACT70.

In ACT70, the processor 101 confirms whether or not the person-to-track determined as the returner is an authenticated member. The processor 101 searches the membership management database 1034 for data record DRC in which the same tracking ID as that set in the field FE of the data record DRB selected in ACT68 is set in the field FN. Then, if the corresponding data record DRC is found, the processor 101 determines YES and proceeds to ACT71.

In ACT71, the processor 101 requests the sales management device 120 to cancel the sale of the product-sold-by-weight by the increased measurement value. For example, the processor 101 transmits the request data for the corresponding request from the communication unit 104 to the communication path 8 in the fixture toward the sales management device 120. Then, the corresponding request data is relayed by the communication unit 7 and transmitted to the sales management device 120 via the communication network 140. The processor 101 includes the identification data for identifying the cancellation request, the product code of the product-sold-by-weight to be canceled, the increased measurement value, and the member ID in the request data. The processor 101 includes the product code included in the received notification data described above as it is in the request data as the product code of the product-sold-by-weight to be canceled. The processor 101 includes the increased measurement value included in the received notification data described above as it is in the request data as the increased measurement value. The processor 101 includes the member ID set in the field FM of the data record DRC found at ACT70 in the request data.

When receiving the request data described above, the sales management device 120 performs a cancellation process for withdrawing the product-sold-by-weight identified by the product code included in the request data from the weight of the product-sold-by-weight registered as being purchased by the member identified by the member ID included in the request data, by the increased measurement value included in the request data.

At ACT70, if the processor 101 confirms that the member is not the authenticated one, the processor 101 determines NO and proceeds to ACT72. For example, if the data record DRC in which the same tracking ID as that set in the field FE of the data record DRB selected at ACT68 is set in the field FN cannot be found from the membership management database 1034, the processor 101 determines that the member is not the authenticated one. This case corresponds to a case in which a customer is startled to the first alarm operation that is performed in response to the customer taking out the product-sold-by-weight from the shelf 1 without knowing the service provided by the store system 100, and thus immediately returns the product-sold-by-weight to the shelf 1.

At ACT68, if the returner cannot be determined, the processor 101 determines NO at ACT69 and proceeds to ACT72. This case corresponds to a case in which the processor 101 determines that the returner is unknown as described above at ACT68. In addition, this case corresponds to a case in which a person who is not tracked by the tracking process due to certain errors returns the product-sold-by-weight.

In ACT72, the processor 101 performs a fourth alarm operation. The fourth alarm operation is an operation for notifying a clerk or the like of an unreasonable return of a product-sold-by-weight performed and for urging him or her to respond to the operation. As the fourth alarm operation, the processor 101 instructs the terminal device used by the clerk to display a screen or output a voice message, for example. As the fourth alarm operation, the processor 101 may perform any operation other than the above, or may perform a plurality of types of operations. Contents such as screens or voice messages may be appropriately determined according to the circumstances of the store where the display fixture 110 is installed.

If ACT67, ACT71 or ACT72 are finished, the processor 101 returns to the standby state of ACT51 to ACT54 in FIG. 13.

If the exit flag set in the field FJ is changed from off to on in any of the data records DRB included in the tracking database 1033, the processor 101 determines YES at ACT54 in FIG. 13 and proceeds to ACT73.

In ACT73, the processor 101 confirms whether or not the person-to-track associated with the exit flag changed to ON state is an authenticated member. The processor 101 selects, from the tracking database 1033, the data record DRB in which the exit flag changed to the ON state described above is set in the field FJ. Then, the processor 101 searches the membership management database 1034 for the data record DRC in which the same tracking ID as that set in the field FE of the selected data record DRB is set in the field FN. Then, if the corresponding data record DRC is found, the processor 101 determines YES and proceeds to ACT74.

In ACT74, the processor 101 requests the sales management device 120 to start the payment. For example, the processor 101 transmits the request data for the corresponding request from the communication unit 104 to the communication path 8 in the fixture toward the sales management device 120. Then, the corresponding request data is relayed by the communication unit 7 and transmitted to the sales management device 120 via the communication network 140. The processor 101 includes identification data for identifying the request to start payment and a member ID set in the field FM of the data record DRC found at ACT73 in the request data. Then, after this, the processor 101 returns to the standby state of ACT51 to ACT54.

If the member is not the authenticated one, and the corresponding data record DRC cannot be found, the processor 101 determines NO at ACT73, passes ACT74, and returns to the standby state of ACT51 to ACT54.

When receiving the above request data, the sales management device 120 instructs the payment device 130 to pay the price for the registered product-sold-by-weight with respect to the member identified by the member ID included in the request data. When receiving the corresponding instruction, the payment device 130 pays the price described above using the payment information registered for the relevant member. The process for this payment may be a process for a well-known payment such as a credit payment OR an electronic money payment.

As is clear from the description provided above, the product monitoring unit 9 of the display fixture 110 forms a decrease amount acquisition portion by executing the processes of ACT41, ACT43 and ACT44 of FIG. 12. That is, the processor 91 of the product monitoring unit 9 acquires a decrease amount if the weight of the product measured by the measuring portion, that is, by the weighing scale 6 is changed in the decrease direction.

The main processing unit 10 of the display fixture 110 forms a specifying portion by executing the processes of ACT60 to ACT62 of FIG. 14. That is, the processor 101 of the main processing unit 10 specifies a customer who took out a product for which weight has changed in the decrease direction from the display section, that is, from the shelf 1.

The main processing unit 10 of the display fixture 110 forms an output portion by executing the process of ACT63 of FIG. 14. That is, the processor 101 of the main processing unit 10 outputs identification information of the customer specified by the specifying portion and the information related to the sale of the product based on the decrease amount acquired by the decrease amount acquisition portion, to the sales management device 120 that manages the information related to the sale in association with the identification information of the customer.

As described above, according to at least one embodiment, if the weight of the product-sold-by-weight measured by the weighing scale 6 of the display fixture 110 is changed in the decrease direction, the decreased amount is acquired. In addition, the customer who took out the product-sold-by-weight for which the weight has changed in the decrease direction is specified. Then, the member ID of the specified customer, the product code of the product-sold-by-weight, and the decreased amount are output to the sales management device 120. Therefore, by installing the display fixture 110, it is possible to support the sale of product-sold-by-weight for which the unit price per unit weight is determined.

In addition, the product monitoring unit 9 of the display fixture 110 forms an increase amount acquisition portion by executing the processes of ACT42, ACT45 and ACT46 of FIG. 12. That is, the processor 91 of the product monitoring unit 9 acquires the increase amount, if the weight of the product measured by the weighing scale 6 is changed in the increase direction.

The main processing unit 10 of the display fixture 110 forms an alarm portion by executing the processes of ACT66 and ACT67 of FIG. 14. That is, the processor 101 of the main processing unit 10 generates an alarm if the increase amount is unreasonable.

As described above, according to at least one embodiment, if the customer returns the product-sold-by-weight once taken out from the display fixture 110 to the container that contains a different product-sold-by-weight of the display fixture 110, for example, the weight of the different product-sold-by-weight increases. If such an unreasonable increase amount is acquired, the alarm operation is performed. Therefore, it is possible to prevent the customer from unreasonably returning the product-sold-by-weight. In addition, since the clerk does not have to constantly monitor the customer, the burden on the clerk is decreased.

Further, the main processing unit 10 of the display fixture 110 forms a second specifying portion by executing the process of ACT66, ACT68 and ACT70 of FIG. 14. That is, the processor 101 of the main processing unit 10 specifies the customer who returned, to the shelf 1, the product for which weight has changed in the increase direction, if the increase amount acquired by the increase amount acquisition portion is reasonable. Then, the processor 101 of the main processing unit 10 executes the process of ACT71 in FIG. 14, and output, to the sales management device 120, the identification information of the customer specified by the second specifying portion and the information related to the cancellation of the product, based on the increase amount acquired by the increase amount acquisition portion.

As described above, according to at least one embodiment, if a reasonable increase amount is acquired as the customer returns the product-sold-by-weight once taken out from the display fixture 110 to the container of the display fixture 110 which contains the same product-sold-by-weight, a request for cancellation process for withdrawing from the weight of the product-sold-by-weight registered as a purchase by the member identified by the member ID is output to the sales management device 120. Therefore, if the customer is an authenticated member, the customer is allowed to freely return the product-sold-by-weight once taken out from the shelf 1 back to the shelf 1.

The main processing unit 10 of the display fixture 110 forms a tracking portion by executing the processes of ACT11 to ACT25 of FIG. 10 and ACT27 to ACT40 of FIG. 11. That is, the processor 101 of the main processing unit 10 tracks customers staying in an area defined with reference to the position of the shelf 1. Then, the processor 101 of the main processing unit 10 specifies a customer among the customers staying in the area, who can take out the product for which weight has changed in the decrease direction from the shelf 1, by executing the processes of ACT60 to ACT62 of FIG. 14.

As described above, according to at least one embodiment, by tracking the customers staying in the purchase area ARA, the customer who can take out the product-sold-by-weight for which the weight has changed in the decrease direction in the display fixture 110 is specified. Therefore, by installing the display fixture 110, it is possible to make an unmanned store.

At least one embodiment can be modified in various ways as follows.

The appearance of the display fixture 110 illustrated in FIG. 1 is an example, and the display fixture 110 according to at least one embodiment may be realized in any other forms. For example, it may be another type such as a trapezoidal type, a top opening type, or the like. Further, the open surface may be provided with a door that can be opened and closed.

A door that allows the open surface to be closed may be provided for the purpose of keeping it warm or cold.

The conditions for detecting exit of the person-to-track from the shelf 1 can be changed as appropriate. For example, the exit of the person-to-track from the shelf 1 may simply be detected in response to the person-to-track entering the confirm area ARD, without considering the preparatory area ARC. Further, for example, the exit of the person-to-track from the shelf 1 may simply be detected in response to the fact that the position of the person-to-track once located in the purchase area ARA is changed to outside the purchase area ARA.

The tracking process, the monitoring process, or the customer response process may be processed in a distributed manner by a plurality of computers. The tracking process, the monitoring process, and the customer response process may all be processed by the same computer. The tracking process and the customer response process may be processed by separate computers, respectively. The tracking process and the monitoring process, and the customer response process may be processed by separate computers, respectively, or the tracking process, and the monitoring process and the customer response process may be processed by separate computers, respectively.

The processor 91 or the processor 101 may execute at least a portion of the registration process in the sales management device 120. The processor 91 or the processor 101 may execute at least a portion of the payment processing in the payment device 130. At least a portion of the customer response process may be executed by the sales management device 120.

Even if the member is an authenticated one, payment may be performed at the check-out corner where the clerk is stationed or at the self-service-type check-out corner.

The product-sold-by-weight may be registered in association with the tracking ID. Then, if the member authentication is performed after starting the registration of the product-sold-by-weight, the member ID may be associated with the product-sold-by-weight. Alternatively, the payment device installed in the tracking area may be used to pay the product-sold-by-weight associated with the person-to-track located in the area corresponding to the payment device.

The person as a target of tracking may be identified by the member ID without using the tracking ID.

The member may be authenticated by biometric authentication such as face authentication based on the image captured by the tracking camera 2.

If the product-sold-by-weight is a food product, for example, the nutritional value per unit weight may be included in the data record DRA included in the product management database 932. Then, the nutritional value corresponding to the decreased weight of the product-sold-by-weight taken out by the customer may be output to the sales management device 120.

Each function realized by the processor 53, 91 or 101 by information processing can also be partially or completely realized by hardware that executes information processing that is not based on a program, such as a logic circuit. Further, each of the functions described above can be realized by combining software control with the hardware described above such as a logic circuit.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sales support device comprising:
a weight measurement device for measuring a weight of a product displayed in a display section; and
a processor configured to:
acquire, from the weight measurement device, a decrease amount if the weight of the product measured by the weight measurement device is decreased;
specify, based on images captured by a camera, a customer who takes out the product for which the weight is decreased from the display section; and
output identification information of the customer specified and information related to a sale of the product based on the decrease amount acquired to a sales management device that manages the information related to the sale in association with the identification information of the customer.

2. The device of claim 1, wherein the processor is further configured to:
acquire, from the weight measurement device, an increase amount if the weight of the product measured by the weight measurement device is increased; and
generate a warning if the increase amount is unreasonable.

3. The device of claim 2, wherein the processor is further configured to:
specify a customer who returns the product for which the weight is increased to the display section, in response to the increase amount acquired being reasonable; and
output, to the sales management device, identification information of the customer specified and information related to a cancellation of the product based on the increase amount acquired.

4. The device of claim 1, wherein the processor is further configured to:
track a customer staying in an area defined based on a position of the display section; and
specify, among customers staying in the area, a customer who is capable of taking out the product for which the weight is decreased from the display section.

5. The device of claim 4, wherein the processor is further configured to analyze changes in a plurality of images captured by a surveillance camera during a monitoring period to specify the customer who is capable of taking out the product.

6. The device of claim 4, wherein the processor is further configured to:
authenticate the identification information of the customer specified via a device that monitors various personal information, member identification, and payment information about a customer registered as a member; and
confirm that the identification information of the customer specified is a legitimate member identification given to the member.

7. The device of claim 6, wherein the processor is further configured to confirm the customer who is capable of taking out the product is the authenticated member.

8. The device of claim 1, wherein the processor is further configured to request the sales management device to register for the sale of the product for which weight has decreased.

9. The device of claim 1, wherein information related to the sale of the product is at least one of identification data for identifying the notification of the decrease, a product code of the product for which weight has decreased, and the decrease amount.

10. A sales support method comprising:
acquiring a decrease amount if a weight of a product measured by a weight measuring device for measuring the weight of the product displayed on a display section is decreased;
specifying a customer who takes out the product for which the weight is decreased from the display section; and
outputting identification information on the specified customer and information related to a sale of the product based on the decrease amount, to a sales management device that manages the information related to the sale in association with the identification information of the customer.

11. The method of claim 10, further comprising:
acquiring an increase amount if the weight of the product measured by the weight measurement device is increased; and
generating a warning if the increase amount is unreasonable.

12. The method of claim 11, further comprising:
specifying a customer who returns the product for which the weight is increased to the display section, in response to the increase amount acquired being reasonable; and
outputting, to the sales management device, identification information of the customer specified and information related to a cancellation of the product based on the increase amount acquired.

13. The method of claim 10, further comprising:
tracking a customer staying in an area defined based on a position of the display section; and
specifying, among customers staying in the area, a customer who is capable of taking out the product for which the weight is decreased from the display section.

14. The method of claim 13, further comprising analyzing changes in a plurality of images captured by a surveillance camera during a monitoring period to specify the customer who is capable of taking out the product.

15. The method of claim 13, further comprising:
authenticating the identification information of the customer specified via a device that monitors various personal information, member identification, and payment information about a customer registered as a member; and
confirming that the identification information of the customer specified is a legitimate member identification given to the member.

16. The method of claim 15, further comprising confirming the customer who is capable of taking out the product is the authenticated member.

17. The method of claim 10, further comprising requesting the sales management device to register for the sale of the product for which weight has decreased.

18. The method of claim 10, wherein information related to the sale of the product is at least one of identification data for identifying the notification of the decrease, a product code of the product for which weight has decreased, and the decrease amount.
